(19) United States
(12) Patent Application Publication
(10) Pub. No.: US 2019/0159493 A1
(43) Pub. Date: May 30, 2019

(54) INFANT FOOD ABLE TO BE CONSUMED BY HAND AND PREPARATION PROCESS

(71) Applicant: Tooji, Estillac (FR)

(72) Inventors: Rémy Mathey, Le Passage d'Agen (FR); Marie-Pierre Montaron, Quetigny (FR); Alexandre Thillier, Dijon (FR); Marc Vignolle, Les Ulis (FR)

(21) Appl. No.: 16/320,971

(22) PCT Filed: Jul. 24, 2017
(86) PCT No.: PCT/FR2017/052046

§ 371 Date: Jan. 25, 2019

(30) Foreign Application Priority Data
Jul. 25, 2016 (FR) 1657113

(51) Int. Cl. A23L 19/00; A23L 3/36; A23L 5/10; A23L 5/00; A23L 29/244; A23P 10/22

(52) U.S. Cl. CPC A23L 19/03; A23L 19/09; A23L 3/364; A23L 5/13; A23V 2300/31; A23L 29/244; A23P 10/22; A23V 2002/00; A23V 2300/20; A23L 5/57

(57) ABSTRACT

A method for preparing an infant food consumable by hand comprises grinding at least one frozen plant base to form grains with a grain size of less than one millimeter, mixing the ground at least one frozen plant base with a natural texturizing agent in a proportion between 2% and 30% by weight based on the final mass of the mixture, and oil and/or at least one aromatic compound in a proportion between 2% and 20% by weight based on the final mass of the mixture, dosing the mixture to prepare individual portions, cooking the individual portions thus prepared in moist heat, freezing the cooked individual portions, and packaging the frozen cooked individual portions.

### CROSS-REFERENCE TO RELATED APPLICATIONS

This application is a national phase entry under 35 U.S.C. § 371 of International Patent Application PCT/FR2017/052046, filed Jul. 24, 2017, designating the United States of America and published in French as International Patent Publication WO 2018/020127 A1 on Feb. 1, 2018, which claims the benefit under Article 8 of the Patent Cooperation Treaty to French Patent Application Serial No. 1657113, filed Jul. 25, 2016.

### TECHNICAL FIELD

This disclosure relates to the field of infant nutrition at the time of diversification. The food product disclosed herein is intended for consumption by babies over 12 months of age. At this age, babies want more autonomy and begin to want to eat alone.

### BACKGROUND

From 6 months of age, the baby's diet should begin to diversify, in particular, by introducing vegetable purée and minced meat or fish. Parents can cook child-friendly food themselves or switch to manufactured products such as baby food jars or frozen baby food.

Purees are adapted to the baby's nutritional needs but are not practical to eat for the baby, as the baby does not have enough agility at this age to eat them alone with a spoon.

From 9 months of age, parents can also introduce pieces into the baby's food so that he or she can get used to the differences in texture and develop chewing.

Chewable baby food that babies can eat alone or in the presence of an adult exist in the state of the art, for example, a piece of bread, a biscuit or pieces of fruit. This is well suited for desserts or snacks but not for a complete meal.

European Patent EP2680706 discloses dehydrated cubes or pieces of natural and chewable fruit/vegetables. This patent relates to a new method for dehydrating natural fruit and/or vegetable products in order to modify their texture properties so as to obtain chewable and non-sticky cubes or pieces for use by persons with or suffering from chewing difficulties, for example, in sweet foods, seasoned dried foods, baby foods, hospital foods, foods for the elderly and/or clinical nutrition for persons with medical conditions. The technology described in this patent concerns only one fruit/vegetable at a time whose objective is to obtain dehydrated pieces. It does not produce a texture product composed of several ingredients, including pieces, that can be directly gripped and eaten by a baby alone.

### BRIEF SUMMARY

The infant food product described herein can be consumed by infants and children by using their hand, and are produced from at least one frozen plant base, using a method in which the following steps are carried out:
a) Grinding at least one frozen plant base with a grain size of less than one millimeter;
b) Mixing the frozen ground product with a natural texturizing agent in a proportion by weight between 2% and 30% based on the final mass of the mixture, as well as a proportion of between 2% and 20% of oil and/or aromatic compounds by weight based on the final mass of the mixture;
c) Dosing the mixture to prepare individual portions;
d) Cooking the individual portions thus prepared in moist heat;
e) Freezing the cooked individual portions; and
f) Packaging the frozen individual portions.

“Plant base” in the sense of the disclosure, means a base consisting of one or more vegetables or fruits.

The plant base obtained by grinding in step a) is referred to as a “fine base” and has a grain size of less than 1 mm. It results from the grinding of at least one type of vegetable or fruit. It can be a mixture of vegetables, fruit or vegetables and fruit.

In a particular embodiment, the method includes the addition of a second plant base, the second plant base having a grain size different from the first plant base, the grain size of the second plant base being greater than one millimeter. This second plant base is referred to as a “base with pieces.” Preferably, the grain size of the second plant base is between 1 mm and 10 mm, even more preferably between 2 mm and 5 mm. This second plant base is ground separately from the fine base, before being mixed with the fine base.

Different types of bases with a characteristic vegetable taste can be used to obtain the infant food according to the disclosure:
green base: green bean, peas
orange base: carrot, pumpkin
yellow base: corn, yellow carrot
red base: tomato
white base: parsnip, Jerusalem artichoke

The list of vegetables and/or fruit constituting these different bases is not exhaustive, just as the list of bases is not exhaustive. It should be understood that at least one plant base can be used in the method according to the disclosure. Preferably, the infant food product comprises a fine plant base and a plant base with pieces. Each of these bases is ground separately. These bases are mixed only once, when each one has been ground.

A natural texturizing agent is added to the plant base(s).

When the infant food contains only a fine base, the texturizing agent is added to the fine base after grinding and prior to dosing.

When the infant food comprises a fine base and a base with pieces, the texturizing agent may be added either to the fine base, or to the base with pieces, or to the mixture of the fine base and the base with pieces. Advantageously, the natural texturizing agent is selected from among corn flour, potato flour, wheat flour, rice flour, manioc flour, corn starch, potato starch, wheat starch, rice starch, and manioc starch.

Advantageously, the aromatic compounds are chosen from the group consisting of aromatic herbs, dairy products, cheese, cream cheese, vegetable broths, meat broths, minced meat, and minced fish.

It should be understood that certain aromatic compounds can also contribute or even constitute the intake of fat. This is the case with cheese. Cheese acts as an aromatic compound and at the same time brings fat to the food. When cheese is used, it is not always necessary to add oil to the food. Minced meat and minced fish also contribute to fat intake.

When oils are used, the oils may be vegetable oils. These vegetable oils include, but are not limited to, avocado, canola, safflower, rapeseed, olive, sunflower, grape seed, corn germ, flaxseed oil or a combination of at least two of these. Preferably, oils rich in unsaturated fatty acids such as rapeseed oil or flavorful oils such as olive oil are used.

In a preferred embodiment, the individual portions prepared in step c) of the method are between 10 grams and 50 grams, preferably between 20 grams and 30 grams.

The method includes a step of cooking individual portions with moist heat. Wet cooking can be done in an open environment or in a closed, waterproof environment. Wet cooking gives the product some flexibility without the product disintegrating. This type of cooking makes it possible to obtain a homogeneous cooking of the product, without formation of skin, without formation of the crusting phenomenon, without the formation of hard fragments or edges that could be a source of rejection by the baby or a danger for the baby.

In one embodiment, cooking is carried out in open molds in a moist atmosphere. In another embodiment, the product is also cooked in a moist environment but is enclosed in a waterproof enclosure, which protects it from excessive humidity that would make it crumble and would deprive it of a sufficient resistance for the baby to hold in his/her hand. The sealed enclosure can be, for example, a sealed tray under partial vacuum, total vacuum or modified atmosphere, or a casing. Preferably, cooking is a cooking with saturated steam between 85° C. and 100° C. for 20 minutes to 1 hour. Even more preferably, cooking is a cooking with saturated steam at 90° C. for 30 minutes. In another particularly preferred embodiment, cooking is cooking with saturated steam at 85° C. for 45 minutes.

The steam cooking of the food can be carried out in sealed trays, open molds or vacuum casings. In a preferred embodiment, the cooking is carried out in sealed trays.

The use of the method according to the disclosure makes it possible to obtain an infant food that is not fried and does not have a crust or a skin. Thanks to the method of preparation, the infant food has the characteristics required to be adapted to the diet of a child who starts to eat alone. Indeed, this food has a good hold when it is in the child's hand but is crushed when it is introduced into the mouth because of the movement of the lips, of the first teeth, and the pressure of the tongue on the palate, as described below.

Thus, the disclosure relates to an infant food obtained directly by a method according to the disclosure, since the properties of the food are linked to this method. This food is pliable, as defined below.

It should be understood that the food is not fried, has no crust or skin and is not coated.

The disclosure also relates to an infant food comprising a fine plant base with a grain size of less than 1 mm and a plant base with pieces with a grain size of more than 1 mm.

Preferably, the grain size of the base with pieces is between 1 mm and 10 mm, even more preferably between 2 mm and 5 mm. The food comprising these two bases is, therefore, a mixture of textures.

In a particular embodiment, the infant food includes, in addition to the fine plant base and the plant base comprising pieces, a natural texturizing agent in a proportion by weight between 2% and 30% based on the final mass as well as a proportion of 2% to 20% of oil and/or aromatic compounds by weight based on the final mass of the mixture. This food is an individual solid pliable portion.

“Pliable” in the sense of the disclosure, means a food product that does not crumble in the hand. In particular, the child must be able to take the food and put it in his/her mouth without it breaking or crumbling. However, this pliable food must be flexible and melt-in-the-mouth so that the part in the child's mouth remains in the mouth. In other words, the piece placed in the mouth separates from the part held by the hand.

It is understood that the infant food is easily grasped by the baby. The latter can eat it alone, by hand or in the presence of an adult. This food is adapted to the baby's nutritional needs. It holds well when it is in the child's hand but is crushed when it is introduced into the mouth because of the movement of the lips, of the first teeth, and the pressure of the tongue on the palate. The result is a “cream” with small melting pieces, easy to swallow and not sticky to the palate. The food is flavorful and has a strong and natural vegetable flavor. The presence of pieces contributes to the development of the baby's senses, through the scheme of colors, tastes and textures (pieces, “cream”). Similarly, since the food is intended to be consumed by hand, it also develops agility and the discovery of different tactile textures.

In one exemplary embodiment, the infant food is shaped like an ingot or a truncated pyramid with a rectangular base 50 mm to 70 mm long. The ingot also has the following sections: the lower base is 25 mm wide, the upper base is 20 mm wide, the ingot is 20 mm high.

The present disclosure will be better understood in the light of the following non-exhaustive exemplary embodiments.

### BRIEF DESCRIPTION OF THE DRAWINGS

FIG. 1 describes the steps in the method for preparing an infant food according to a first embodiment.

FIG. 2 describes the steps in the method for preparing an infant food according to a second embodiment.

FIG. 3 describes the steps in the method for preparing an infant food according to a third embodiment.

### DETAILED DESCRIPTION

### EXAMPLE 1

### A Method for Preparing Infant Food

The method first comprises the preparation of two plant bases.

Preparation of the fine plant base: The raw materials used are frozen vegetables. The raw materials used to make up the fine base are weighed using a balance. Frozen vegetable raw materials are finely ground using a grinder. The grain size is less than 1 mm. Texturizing agents and fat are added to this fine base according to the composition described in Table 1.

In parallel with the preparation of this fine base, a second base is prepared. To do this, the frozen vegetable raw materials are weighed using a scale, mixed and then coarsely ground frozen using a grinder to produce pieces between 2 mm and 5 mm in size.

The fine base and the second base are then mixed. The mixture is then processed according to one of the three methods described below:

### EXAMPLE 1a

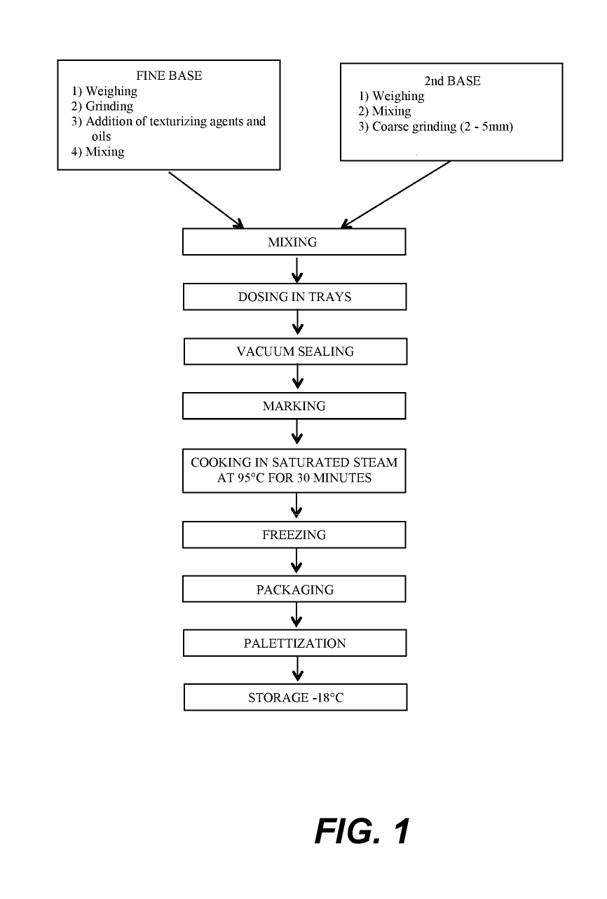

### Dosing and Cooking of Portions in Sealed Trays (FIG. 1)

The mixture previously obtained of fine base and second base is then dosed in trays. Trays include forms into which the mixture is poured. These forms are ingot-shaped molds, i.e., truncated pyramid-shaped molds with a lower rectangular base having a section of 50 mm to 70 mm long×25 mm wide and an upper rectangular base having a section of 50 mm to 70 mm long ×20 mm wide×20 mm high. The trays containing the mixture are sealed under vacuum and then marked. The sealed trays are placed in a saturated steam oven at 90° C. for 30 minutes. Steam cooking allows a homogeneous cooking with a better thermal transfer coefficient and the sealing protects the mixture from excessive hydration by saturating with water vapor. After cooking, the trays are frozen and then packaged. The packaged products are palletized and stored at −18° C.

### EXAMPLE 1b

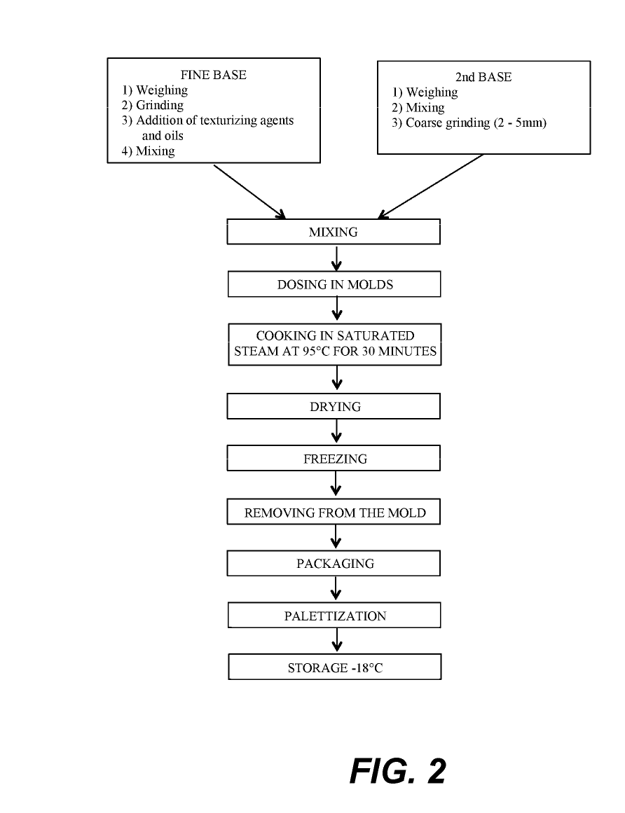

### Dosing and Cooking in Open Molds (FIG. 2)

The mixture previously obtained of the fine base and the second base is molded in open ingot-shaped molds, i.e., in the shape of a truncated pyramid with a rectangular base having a section 60 mm long×25 mm wide and ×20 mm high. The molds are in the form of 600 mm×400 mm sheets and have 13 rows of 8 cells, each cell measuring 25 mm wide×60 mm long×20 mm deep, the cells being 10 mm apart. Then the open molds are placed in a saturated steam oven at 90° C. for 30 minutes. The molds are then dried and placed in the freezer. The portions are then removed from the molds and packaged. The packaged products are palletized and stored at −18° C.

### EXAMPLE 1c:

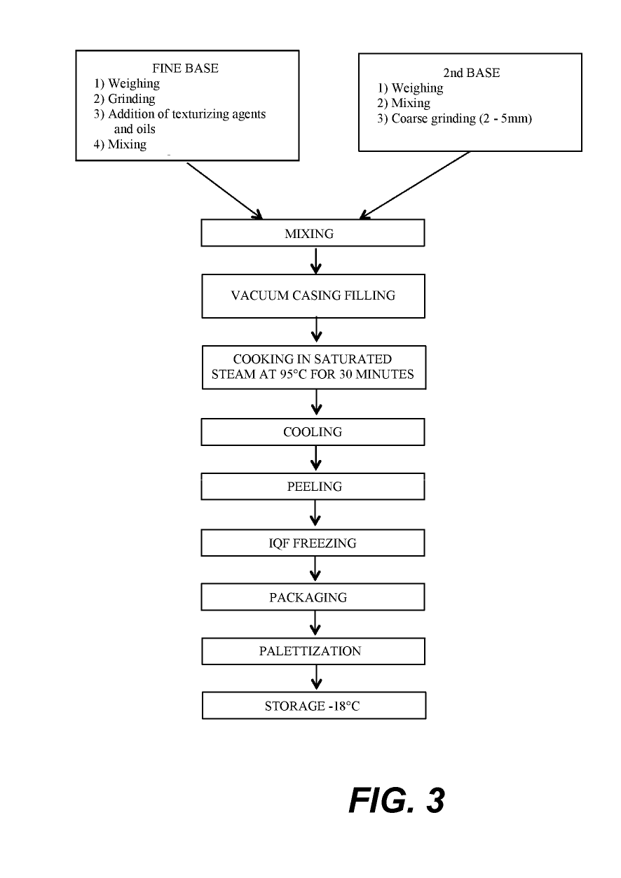

### Pushing the Mixture into Casings Under a Vacuum and Cooking in the Casing (FIG. 3)

The fine base and second base mixture previously obtained is pushed under vacuum into casings and then cooked under steam saturation conditions at 90° C. for 30 minutes. The casing has the advantage of being waterproof and resistant. In addition, the casing exerts a pressure on the mixture during cooking, which increases the density of the finished infant food. The casing containing the mixture is cooled after cooking. The product is then peeled and placed in IQF (Individual Quick Frozen) freezing. IQF freezing allows individual portions to be frozen without sticking together. The frozen product is then packaged. The packaged products are palletized and stored at −18° C.

Before being consumed by the baby, the food will be heated in the microwave oven for 3 to 4 minutes at low power. If the products are manufactured according to the method described in Example 1a, i.e., in a sealed tray, the tray can also be alternatively defrosted in a water bath. The ingots must reach a maximum temperature of 50° C., preferably between 35° C. and 50° C., even more preferably between 35° C. and 45° C. The food should not be overheated or the baby might burn his/her hand when grabbing it and burn his/her mouth, lips and tongue when eating it.

### EXAMPLE 2

### Infant Food with Green Vegetables and Cheese Base

In this example, the vegetable bases used are a green base and a second plant base, the mixture of orange pieces. The green base used includes green beans, peas and potatoes. This green base is the fine base. The second base is a mixture of pieces including carrots and spinaches. The carrots and spinaches in this second base are ground into small pieces of 2 mm to 5 mm.

The vegetables used to prepare the two bases are frozen vegetables using the IQF freezing method. Indeed, frozen vegetables are thus individualized, even in the frozen state, which facilitates the handling and grinding thereof. Vegetables frozen using other techniques have a tendency to agglomerate, which would require at least partial thawing of the vegetable block to grind it, which is a waste of time and energy. IQF frozen vegetables also limit the temperature increase during the step of grinding, which preserves the IQF frozen vegetable.

The composition of the infant food is detailed in Table 1. This is perfectly adapted to the baby's specific nutritional needs, in particular, by not adding any salt other than the one provided by cheese, preservatives or sugar.

The percentages in Table 1 are those of the ingredients in the mixture by weight before cooking.

TABLE 1
Composition of an infant food.

| Raw materials | % |
|---|---|
| IQF organic green bean | 29.00% |
| IQF organic carrot | 20.00% |
| IQF organic ripened goat cheese | 12.50% |
| IQF Organic peas | 12.40% |
| IQF Organic potato | 10.00% |
| Organic potato starch | 8.50% |
| IQF Organic crushed spinaches | 7.30% |
| IQF Organic chives 3 mm | 0.30% |

Fat here is provided only by cheese. The food in this example does not include the addition of oil.

The aromatic compounds consist of cheese and chives.

The texturizing agent is potato starch. However, in this example, the green base potato also contributes to the intake of texturizing agent through the presence of starch. However, the intake of texturizing agent from the potatoes is minimal compared to potato starch.

The infant food is obtained according to the method described in Example 1. The portions are obtained by molding according to Example 1b.

The final infant food is in the form of an ingot, for example, a truncated pyramid with a lower rectangular base having a section 60 mm long×25 mm wide, an upper rectangular base having a section 60 mm long×20 mm wide, and ×20 mm high. Five to six ingots, the amount to be consumed by the child at lunch or dinner time, are taken out of the freezer, removed from the packaging, and placed in the microwave for 3 to 4 minutes at low power so that the ingots reach a maximum temperature of 50° C., preferably between 35° C. and 50° C., even more preferably between 35° C. and 45° C. The food should not be overheated or the baby might burn his/her hand when grabbing it and burn his/her mouth, lips and tongue when eating it.

After adequate heating, the baby can eat each of the ingots by hand. The food keeps its shape in his/her hand but crushes when he/she puts it in his/her mouth, because of the movement of the lips, of the first teeth, and a pressure of the tongue on the palate. The result in the mouth is the forming of a “cream” with the presence of small melting pieces, easily swallowed by the baby and not sticky to the palate.

Food enables the baby to develop agility, grip, appreciation of various textures and new tastes.

### EXAMPLE 3

### Infant Food Based on Orange Vegetables

In this example, the vegetable bases used are an orange base and a second plant base, and the mixture of pieces. The orange base used includes carrots and 50% of the red peppers used in the recipe of the finished product. This orange base is the fine base. The mixture of pieces includes aubergines, 50% of the remaining red peppers, onions and potatoes. The vegetables of this second base are ground into small pieces of 2 mm to 5 mm.

The vegetables used to prepare the two bases are frozen vegetables using the IQF freezing method. Indeed, frozen vegetables are thus individualized, even in the frozen state, which facilitates the handling and grinding thereof. Vegetables frozen using other techniques have a tendency to agglomerate, which would require at least partial thawing of the vegetable block to grind it, which is a waste of time and energy. IQF frozen vegetables also limit the temperature increase during the step of grinding, which preserves the IQF frozen vegetable.

The composition of the infant food is detailed in Table 2. This is perfectly adapted to the baby's specific nutritional needs, in particular, by not adding any salt other than the one provided by cheese, preservatives or sugar.

The percentages in Table 2 are by weight of the mixture prior to cooking.

TABLE 2
Composition of an infant food.

| Raw materials | % |
|---|---|
| IQF Organic carrot | 44% |
| IQF Organic aubergine | 19.70% |
| Organic potato starch | 8.50% |
| IQF Organic red pepper | 15% |
| IQF Organic onion | 5% |
| IQF Organic potato | 5% |
| Organic olive oil | 2.50% |
| IQF Organic chopped basil | 0.30% |

Fats here are provided only by olive oil. The aromatic compounds are made up of basil and olive oil. The texturizing agent is potato starch.

The infant food is obtained according to the method described in Example 1. The portions are obtained by molding according to Example 1b.

The final infant food is in the form of an ingot, for example, a truncated pyramid with a lower rectangular base having a section 60 mm long×25 mm wide, an upper rectangular base having a section 60 mm long×20 mm wide, and ×20 mm high. Five to six ingots, the amount to be consumed by the child at lunch or dinner time, are taken out of the freezer, removed from the packaging, and placed in the microwave for 3 to 4 minutes at low power so that the ingots reach a maximum temperature of 50° C., preferably between 35° C. and 50° C., even more preferably between 35° C. and 45° C. The food should not be overheated or the baby might burn his/her hand when grabbing it and burn his/her mouth, lips and tongue when eating it.

After adequate heating, the baby can eat each of the ingots by hand. The food keeps its shape in his/her hand but crushes when he/she puts it in his/her mouth, because of the movement of the lips, of the first teeth, and a pressure of the tongue on the palate. The result in the mouth is the forming of a “cream” with the presence of small melting pieces, easily swallowed by the baby and not sticky to the palate.

Food enables the baby to develop agility, grip, appreciation of various textures and new tastes.

1.-10. (canceled)

11. A method for preparing an infant food consumable by hand, comprising:
grinding at least one frozen plant base to form grains of the at least one frozen plant base having a grain size of less than one millimeter;
mixing the ground at least one frozen plant base with a natural texturizing agent in a proportion between 2% and 30% by weight based on the final mass of the mixture, and oil and/or at least one aromatic compound in a proportion between 2% and 20% by weight based on the final mass of the mixture;
dosing the mixture to prepare individual portions;
cooking the individual portions in moist heat;
freezing the cooked individual portions; and
packaging the frozen cooked individual portions.

12. The method of claim 11, further comprising:
grinding a second frozen plant base to form grains of the second frozen plant base having a grain size greater than 1 mm; and
adding the second plant base to the ground at least one frozen plant base.

13. The method of claim 12, wherein the natural texturizing agent is selected from the group consisting of corn flour, potato flour, wheat flour, rice flour, manioc flour, corn starch, potato starch, wheat starch, rice starch, and manioc starch.

14. The method of claim 13, wherein mixing the ground at least one frozen plant base with oil and/or at least one aromatic compound comprises mixing the ground at least one frozen plant base with at least one aromatic compound selected from the group consisting of an herb, a dairy product, a vegetable broth, a meat broth, and a minced meat.

15. The method of claim 14, wherein the at least one aromatic compound comprises cheese.

16. The method of claim 14, wherein the at least one aromatic compound comprises fish.

17. The method of claim 14, wherein cooking the individual portions in moist heat comprises cooking the individual portions with saturated steam at a temperature between 85° C. and 100° C. for 20 minutes to 1 hour.

18. The method of claim 17, wherein the infant food is not fried and does not have a crust or a skin.

19. The method of claim 11, wherein the natural texturizing agent is selected from the group consisting of corn flour, potato flour, wheat flour, rice flour, manioc flour, corn starch, potato starch, wheat starch, rice starch, and manioc starch.

20. The method of claim 11, wherein mixing the ground at least one frozen plant base with oil and/or at least one aromatic compound comprises mixing the ground at least one frozen plant base with at least one aromatic compound selected from the group consisting of an herb, a dairy product, a vegetable broth, a meat broth, and a minced meat.

21. The method of claim 14, wherein cooking the individual portions in moist heat comprises cooking the individual portions with saturated steam at a temperature between 85° C. and 100° C. for 20 minutes to 1 hour.

22. The method of claim 11, wherein the infant food is not fried and does not have a crust or a skin.

23. A pliable infant food formed by a method, comprising:
grinding at least one frozen plant base to form grains of the at least one frozen plant base having a grain size of less than one millimeter;
mixing the ground at least one frozen plant base with a natural texturizing agent in a proportion between 2% and 30% by weight based on the final mass of the mixture, and oil and/or at least one aromatic compound in a proportion between 2% and 20% by weight based on the final mass of the mixture;
dosing the mixture to prepare individual portions;
cooking the individual portions in moist heat;
freezing the cooked individual portions; and
packaging the frozen cooked individual portions.

24. An infant food product comprising a fine plant base comprising grains having a grain size of less than 1 mm and another plant base comprising grains having a grain size of more than 1 mm.

25. The infant food of claim 24, wherein the another plant base comprises grains having a grain size between 1 mm and 10 mm.

26. The infant food of claim 24, further comprising a natural texturizing agent in a proportion between 2% and 30% by weight based on the final mass of the infant food product, and oil and/or at least one aromatic compound in a proportion between 2% and 20% by weight based on the final mass of the infant food product.
